(19) United States
(12) Patent Application Publication
(10) Pub. No.: US 2025/0142300 A1
(43) Pub. Date: May 1, 2025

(54) METHODS FOR REPORTING SENSING DATA, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN)

(73) Assignee: Beijing Xiaomi Mobile Software Co., Ltd., Beijing (CN)

(21) Appl. No.: 18/837,034

(22) PCT Filed: Feb. 10, 2022
(86) PCT No.: PCT/CN2022/075912

§ 371 Date: Aug. 8, 2024

(51) Int. Cl. H04W 4/38; H04W 24/10

(52) U.S. Cl. CPC H04W 4/38; H04W 24/10

(57) ABSTRACT

A method, communication device and non-transitory computer storage media configured for reporting sensing, where sensing data corresponding to a sensing service is reported based on information on a sensing policy. The sensing data indicates features of a sensed object. Reporting involves a control plane network function, which includes access and mobility management function (AMF), session management function (SMF), and policy control function (PCF). The sensing policy may define various aspects such as service type, object type, data collection manner and frequency, and reporting parameters. Sensing data can be raw or processed, and services may be triggered by applications or network functions. Information on the sensing policy is received during network registration or after service triggering.

### CROSS REFERENCE TO RELATED APPLICATIONS

The present application is a U.S. national phase of International Application No. PCT/CN2022/075912, filed on Feb. 10, 2022, the disclosure of which is incorporated herein by reference in its entirety for all purposes.

### TECHNICAL FIELD

The present disclosure relates to but is not limited to the field of wireless communication technologies, and in particular to methods for reporting sensing data, a communication device, and a storage medium.

### BACKGROUND

The development of technologies such as network communication and artificial intelligence (AI) has promoted the intelligence of many industries. Emerging businesses such as smart transportation, smart cities, smart medical care, smart factories, and unmanned driving are deeply integrated with communication networks and have entered a new stage of development. In addition to communication requirements, the above businesses also have requirements of sensing services. For example, the unmanned driving service needs to sense environmental information around the vehicle in real time when the vehicle is driving. Here, the environmental information includes distances of one or more vehicles ahead, weather conditions and traffic light signals, so that a vehicle driving policy can be adjusted in real time to ensure the safety of automatic driving.

### SUMMARY

Embodiments of the present disclosure disclose method for reporting sensing data, a communication device, and a storage medium.

According to a first aspect of the embodiments of the present disclosure, there is provided a method for reporting sensing data. The method is performed by a first terminal and includes:
reporting sensing data corresponding to a sensing service based on information on a sensing policy; where the sensing data is configured to indicate one or more features of a sensed object of the sensing service.

According to a second aspect of the embodiments of the present disclosure, there is provided a method for reporting sensing data. The method is performed by a network function (NF) and includes: receiving sensing data corresponding to a sensing service sent by a first terminal; where the sensing data is reported based on information on a sensing policy and is configured to indicate one or more features of a sensed object of the sensing service.

According to a third aspect of the embodiments of the present disclosure, there is provided a method for reporting sensing data. The method is performed by a sensing function (SF) and includes: receiving sensing data corresponding to a sensing service sent by a first terminal; where the sensing data is reported based on information on a sensing policy and is configured to indicate one or more features of a sensed object of the sensing service.

According to a fourth aspect of the embodiments of the present disclosure, there is provided communication device, including: a processor; and a memory configured to store executable instructions by the processor. The processor is configured to implement the method according to any embodiment of the present disclosure when running the executable instructions.

According to a fifth aspect of the embodiments of the present disclosure, there is provided a computer storage medium, which stores a computer-executable program that, when executed by a processor, implements any of the method described in any embodiment of the present disclosure.

In the embodiment of the present disclosure, based on the information on the sensing policy, the sensing data corresponding to the sensing service is reported; where the sensing data is configured to indicate the features of the sensed object of the sensing service. In this way, the network can execute applications in various scenarios based on the reported sensing data corresponding to the sensing service, meeting sensing needs of applications associated with the features of the sensed object in the network. Compared with the way that the sensing data cannot be provided to the network, a combination of the sensing function and wireless network communication function is realized, expanding functions of the network.

### BRIEF DESCRIPTION OF THE DRAWINGS

FIG. 1 is a schematic structural diagram of a wireless communication system according to an exemplary embodiment.

FIG. 2 is a schematic diagram of a radar system according to an exemplary embodiment.

FIG. 3 is a flowchart of a method for reporting sensing data according to an exemplary embodiment.

FIG. 4 is a flowchart of a method for reporting sensing data according to an exemplary embodiment.

FIG. 5 is a flowchart of a method for reporting sensing data according to an exemplary embodiment.

FIG. 6 is a flowchart of a method for reporting sensing data according to an exemplary embodiment.

FIG. 7 is a flowchart of a method for reporting sensing data according to an exemplary embodiment.

FIG. 8 is a flowchart of a method for reporting sensing data according to an exemplary embodiment.

FIG. 9 is a flowchart of a method for reporting sensing data according to an exemplary embodiment.

FIG. 10 is a flowchart of a method for reporting sensing data according to an exemplary embodiment.

FIG. 11 is a flowchart of a method for reporting sensing data according to an exemplary embodiment.

FIG. 12 is a flowchart of a method for reporting sensing data according to an exemplary embodiment.

FIG. 13 is a flowchart of a method for reporting sensing data according to an exemplary embodiment.

FIG. 14 is a flowchart of a method for reporting sensing data according to an exemplary embodiment.

FIG. 15 is a flowchart of a method for reporting sensing data according to an exemplary embodiment.

FIG. 16 is a flowchart of a method for reporting sensing data according to an exemplary embodiment.

FIG. 17 is a flowchart of a method for reporting sensing data according to an exemplary embodiment.

FIG. 18 is a flowchart of a method for reporting sensing data according to an exemplary embodiment.

FIG. 19 is a flowchart of a method for reporting sensing data according to an exemplary embodiment.

FIG. 20 is a flowchart of a method for reporting sensing data according to an exemplary embodiment.

FIG. 21 is a flowchart of a method for reporting sensing data according to an exemplary embodiment. FIG. 22 is a schematic structural diagram of an apparatus for reporting sensing data according to an exemplary embodiment.

FIG. 23 is a schematic structural diagram of an apparatus for reporting sensing data according to an exemplary embodiment.

FIG. 24 is a schematic structural diagram of a terminal according to an exemplary embodiment.

FIG. 25 is a block diagram of a base station according to an exemplary embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the present disclosure as detailed in the appended claims.

Terms used in the embodiments of the present disclosure are for the purpose of describing specific embodiments only, and are not intended to limit the embodiments of the present disclosure. The singular forms “a,” “an,” and “this” used in the embodiments of the present disclosure and the appended claims are also intended to include plural forms, unless the context clearly indicates other meanings. It should also be understood that the term “and/or” as used herein refers to and includes any and all possible combinations of one or more of the items listed in the associated list.

It should be understood that although terms first, second, third, etc., may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of,” “when,” or “in response to determining.”

For the purpose of simplicity and ease of understanding, the present disclosure uses the terms “greater than” or “less than” when characterizing the size relationship. However, those skilled in the art can understand that the term “greater than” also encompasses the meaning of “greater than or equal to”, and “less than” also encompasses the meaning of “less than or equal to.”

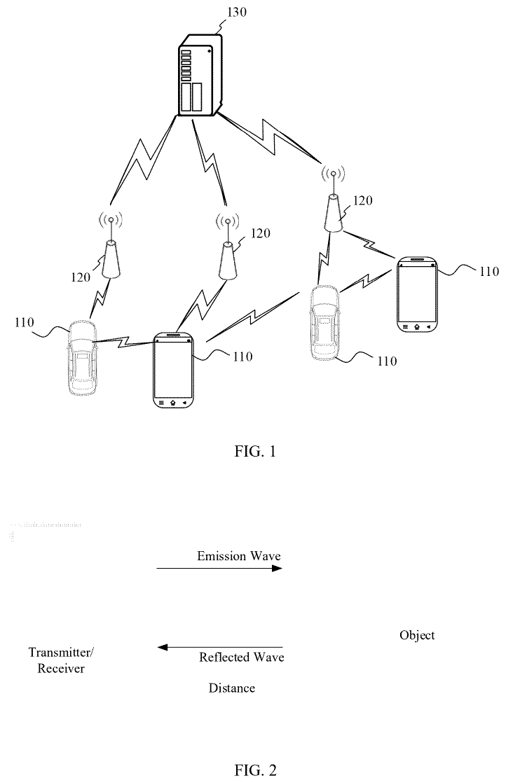

Referring to FIG. 1, FIG. 1 is a schematic structural diagram showing a wireless communication system provided in an embodiment of the present disclosure. As shown in FIG. 1, the wireless communication system is a communication system based on a mobile communication technology, and may include several user equipment (UE) 110 and several base stations 120.

The UE 110 may be a device that provides voice and/or data connectivity to a user. The UE 110 may communicate with one or more core networks via a radio access network (RAN). The UE 110 may be an Internet of Things terminal, such as a sensor device, a mobile phone and a computer with an Internet of Things UE. For example, the UE 110 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment. Or, the UE 110 may be a device of an unmanned aerial vehicle. The UE 110 may be a vehicle-mounted device, such as a driving computer with a wireless communication function or a wireless communication device externally connected to a driving computer. The UE 110 may also be a roadside device, such as a street lamp, a signal lamp, or other roadside devices with a wireless communication function.

The base station 120 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN).

The base station 120 may be an evolved base station (eNB) used in the 4G system. Or, the base station 120 may be a centralized distributed architecture base station (gNB) used in the 5G system. When the base station 120 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 120 is not limited in the embodiments of the present disclosure.

A wireless connection may be established between the base station 120 and the UE 110 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between UEs 110, for example, a vehicle to vehicle (V2V) communication, a vehicle to infrastructure (V2I) communication and a vehicle to pedestrian (V2P) communication in a vehicle to everything (V2X) communication.

Herein, the above-mentioned UE can be considered as a terminal device of the following embodiments.

In some embodiments, the above wireless communication system may further include a network management device 130.

Several base stations 120 are connected to the network management device 130, respectively. The network management device 130 may be an access and mobility management function (AMF), a session management function (SMF), a user plane function (UPF), a policy control function (PCF), a network repository function (NRF), etc. The implementation form of the network management device 130 is not limited in the embodiments of the present disclosure.

In order to facilitate the understanding of those skilled in the art, multiple implementations are enumerated in the embodiments of the present disclosure to clearly explain the technical solution of the embodiments of the present disclosure. Those skilled in the art can understand that multiple embodiments provided by the present disclosure can be executed individually or in combination with the methods of other embodiments in the present disclosure, or individually or in combination with some of the methods in other relevant techniques, which is not limited in the embodiments of the present disclosure.

In order to better understand the technical solution described in any embodiment of the present disclosure, application scenarios in the relevant technology will be explained firstly.

With the development and continuous evolution of the mobile communication technology, it has evolved into a network with a large number of mobile network base stations and intelligent terminals, and functions of base stations and terminals are constantly enhancing. If sensing functions are given to base stations and/or terminals deployed with seamless coverage, rapid development, growth, and popularization of numerous intelligent services that rely on the sensing functions will be promoted.

In an embodiment, sensing technology can utilize wireless signals to sense targets or states of the surrounding environment. For example, information such as signal strength and Doppler frequency shift of wireless terminals or base stations can be sensed. And a result is output after calculation and processing, and the out result can include a size, a position, and a speed of a target, etc.

In an embodiment, in the sensing processing flow of the sensing technology, there are functions involved, such as a transmitter that performs sensing signal transmission, a receiver that performs sensing signal reception, and an initiator that specifically triggers a sensing service. These functions can include various 3rd generation partnership project (3GPP) and non-3GPP terminal functions, 3GPP and non-3GPP network functions, and application functions. In this way, effective sensing of a tested object in the sensing service can be realized, meeting requirements of the sensing service in a specific scenario.

However, there is no solution for implementing a sensing service in a communication network (for example, a sensing service based on enhanced 5G network architecture). Therefore, how to meet needs of the communication and sensing service in various scenarios is an important but unresolved problem for the application of the communication technology in various vertical industries.

In related technologies, the implementation of sensing functions basically relies on specialized sensing equipment or devices, such as sensors, cameras, and radars. However, specialized equipment often has high costs and is inflexible in deployment, resulting in many limitations in usage scenarios and performance of the sensing service.

In an embodiment, radar (radio detection and ranging) is a detection system that uses radio waves to determine the distance (range), angle, and/or velocity of an object. Radar can be used to detect aircraft, ships, spacecraft, missiles, motor vehicles, meteorology, and/or terrain.

In an embodiment, please refer to FIG. 2, a radar system includes:
a transmitter that generates electromagnetic waves in a radio or microwave field; and
a receiver and processor for determining object properties.

Herein, radar technology needs specialized equipment, which is costly and cannot be deployed and used on demand. In addition, the use of frequency bands without unified frequency band use management easily causes interference.

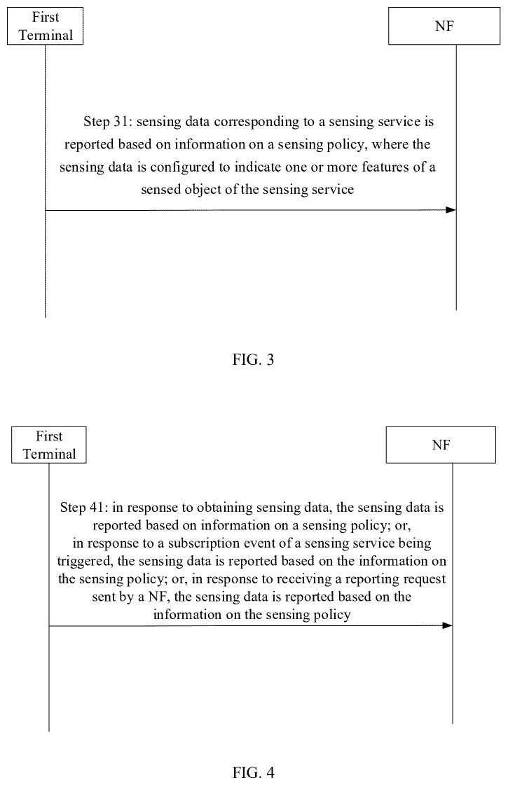

As shown in FIG. 3, this embodiment provides a method for reporting sensing data. The method is performed by a first terminal and includes step 31.

In step 31, sensing data corresponding to a sensing service is reported based on information on a sensing policy.

The sensing data is configured to indicate one or more features of a sensed object of the sensing service.

Herein, the terminal involved in the present disclosure may be, but is not limited to, a mobile phone, a wearable device, a vehicle-mounted terminal, and a road side unit (RSU), a smart home terminal, an industrial sensing device, and/or a medical device, etc. In some embodiments, the terminal may be a Redcap terminal or a new radio (NR) terminal of a predetermined version (for example, a NR terminal of R17).

However, it should be noted that this embodiment is not limited to being performed by the terminal. In specific scenarios, this embodiment can also be performed by a base station or other network communication nodes in a core network, and is not limited herein. For example, in scenarios where the base station serves as a receiver and/or a transmitter in a sensing service, this embodiment can also be performed by the base station. In scenarios where a core network device serves as a receiver and/or a transmitter in the sensing service, this embodiment can also be performed by the core network device. It should be noted that the schematic representation of the terminal as the execution subject in the present disclosure does not limit the technical solution of the present disclosure.

The base station involved in the present disclosure may be an access device for a terminal to access a network. Herein, the base station can be various types of base stations, for example, a base station of the third generation mobile communication (3G) network, a base station of the fourth generation mobile communication (4G) network, a base station of the fifth generation mobile communication (5G) network, or other evolved base station.

In the embodiment of the present disclosure, the sensing data of the sensing service can be reported to a core network device based on the information on a sensing policy. The core network device may be a device with an access and mobility management function (AMF), a session management function (SMF), a sensing function (SF) or a policy control function (PCF).

In an embodiment, the sensing data can be reported through a control plane network function (NF) based on the information on a sensing policy. The control plane NF includes one or more of the following: an access and mobility management function (AMF), a session management function (SMF), and a policy control function (PCF). For example, based on the information on the sensing policy, the sensing data can be reported to the SF through the control plane NF.

In an embodiment, based on the information on the sensing policy, the first terminal reports the sensing data of the sensing service to the core network through a base station in an access network, where the sensing data indicates one or more features of a sensed object of the sensing service. It should be noted that the features of the sensed object can be at least one of features such as a speed, a shape, and a location of the sensed object.

In an embodiment, during a network registration process of the first terminal, the information on the sensing policy is received. Based on the information on the sensing policy, the sensing data of the sensing service is reported. The sensing data indicates the features of the sensed object.

In an embodiment, after the sensing service is triggered, the information on the sensing policy is received. Based on the information on the sensing policy, the sensing data of the sensing service is reported. The sensing data indicates the features of the sensed object.

Herein, the information on the sensing policy can indicate a policy for reporting the sensing data and/or a policy for executing the sensing service.

In some embodiments, the information on the sensing policy indicates one or more of the following of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, and a type of a sensing signal.

In some embodiments, the type of the sensing service may be one of the following: a service type that senses a shape of a target object, a service type that senses a position of the target object, or a service type that senses a running speed of the target object.

In other embodiments, the type of the sensing service may be one of the following: a sensing service type where both the transmitter and the receiver of the sensing signal are terminals, a sensing service type where the transmitter of the sensing signal is a base station and the receiver is a terminal, or a sensing service type where the transmitter and the receiver of the sensing signal are different terminals.

In an embodiment, the type of the sensed object may be a type of a sensed target object, for example, a moving target and a stationary target.

In an embodiment, based on the information on the sensing policy, the sensing data of the sensing service is reported according to the reporting mode of the sensing data indicated by the information on the sensing policy; where the sensing data indicates the features of the sensed object. Herein, the reporting mode of the sensing data can be a reporting manner. For example, a manner in reporting according to a predetermined period.

In an embodiment, based on the information on the sensing policy, the sensing data of the sensing service is reported according to the reporting path of the sensing data indicated by the information on the sensing policy; where the sensing data indicates the features of the sensed object. Herein, the reporting path of the sensing data can be a path for the first terminal to report the sensing data through a base station.

In an embodiment, based on the information on the sensing policy, the sensing data of the sensing service is reported according to the reporting format of the sensing data indicated by the information on the sensing policy; where the sensing data indicates the features of the sensed object.

In an embodiment, the sensing data of the sensing service is obtained from the first terminal; based on the information on the sensing policy, the sensing data of the sensing service is reported; where the sensing data indicates the features of the sensed object.

In an embodiment, the sensing data of the sensing service is obtained from a base station; based on the information on the sensing policy, the sensing data of the sensing service is reported; where the sensing data indicates the features of the sensed object. Herein, the sensing data of the sensing service sent by the base station can be received.

In an embodiment, the sensing data of the sensing service is obtained from a second terminal; based on the information on the sensing policy, the sensing data of the sensing service is reported; where the sensing data indicates the features of the sensed object. The sensing data sent by the second terminal can be received.

In an embodiment, in response to obtaining the sensing data of the sensing service, based on the information on the sensing policy, the sensing data of the sensing service is reported; where the sensing data indicates the features of the sensed object. It should be noted that the sensing data reported by the first terminal is raw data obtained by the first terminal. After obtaining the raw data, a network performs preprocessing on the raw data.

In an embodiment, in response to obtaining the sensing data of the sensing service, preprocessing is performed on the sensing data of the sensing service; based on the information on the sensing policy, the preprocessed sensing data of the sensing service is reported, where the sensing data indicates the features of the sensed object. It should be noted that the preprocessing can be that the first terminal extracts one or more predetermined features from the raw data of the sensing data.

In an embodiment, in response to a subscription event of the sensing service being triggered, the sensing data of the sensing service is obtained; based on the information on the sensing policy, the sensing data is reported, where the sensing data indicates the features of the sensed object.

In an embodiment, a reporting request sent by a network (for example, NF) is received; in response to receiving the reporting request, the sensing data of the sensing service is obtained; based on the information on the sensing policy, the sensing data is reported, where the sensing data indicates the features of the sensed object.

In an embodiment, information on a sensing policy is received; the sensing service is performed based on the information on the sensing policy to obtain the sensing data; based on the information on the sensing policy, the sensing data is reported, where the sensing data indicates the features of the sensed object.

In an embodiment, information on a sensing policy is obtained; in response to a sensing application of a terminal triggering the sensing service, the sensing service is performed based on the information on the sensing policy to obtain the sensing data; based on the information on the sensing policy, the sensing data is reported, where the sensing data indicates the features of the sensed object. Herein, the sensing application of the terminal is an upper layer sensing application of the first terminal or an upper layer sensing application of a second terminal, where the second terminal is a sending end that sends sensing information to the first terminal.

In an embodiment, information on a sensing policy is obtained; in response to a sensing application of a base station triggering the sensing service, the sensing service is performed based on the information on the sensing policy to obtain the sensing data; based on the information on the sensing policy, the sensing data is reported, where the sensing data indicates the features of the sensed object.

In an embodiment, information on a sensing policy is obtained; in response to a network function (NF) triggering the sensing service, the sensing service is performed based on the information on the sensing policy to obtain the sensing data; based on the information on the sensing policy, the sensing data is reported, where the sensing data indicates the features of the sensed object. Herein, the NF can be a sensing application function of a network control plane.

In an embodiment, information on a sensing policy is obtained; in response to an application function (AF) triggering the sensing service, the sensing service is performed based on the information on the sensing policy to obtain the sensing data; based on the information on the sensing policy, the sensing data is reported, where the sensing data indicates the features of the sensed object.

In an embodiment, information on a sensing policy is obtained; in response to a sensing function (SF) triggering the sensing service, the sensing service is performed based on the information on the sensing policy to obtain the sensing data; based on the information on the sensing policy, the sensing data is reported, where the sensing data indicates the features of the sensed object.

In the embodiment of the present disclosure, based on the information on the sensing policy, the sensing data corresponding to the sensing service is reported; where the sensing data is configured to indicate the features of the sensed object of the sensing service. In this way, the network can execute applications in various scenarios based on the reported sensing data of the sensing service, meeting sensing needs of applications associated with the features of the sensed object in the network. Compared with the way that the sensing data cannot be provided to the network, a combination of the sensing function and wireless network communication function is realized, expanding functions of the network.

It should be noted that those skilled in the art can understand that the methods provided in the embodiments of the present disclosure can be executed separately or together with some methods in the embodiments of the present disclosure or related technologies.

In an embodiment, the information on the sensing policy indicates one or more of the following of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, and a type of a sensing signal.

As shown in FIG. 4, this embodiment provides a method for reporting sensing data, which includes step 41.

In step 41, in response to obtaining sensing data, the sensing data is reported based on information on a sensing policy;
or,
in response to a subscription event of a sensing service being triggered, the sensing data is reported based on the information on the sensing policy;
or,
in response to receiving a reporting request sent by a network function (NF), the sensing data is reported based on the information on the sensing policy.

In an embodiment, information on a sensing policy is received; the sensing service is performed based on the information on the sensing policy to obtain the sensing data; in response to obtaining the sensing data, the sensing data is reported based on the information on the sensing policy.

In an embodiment, information on a sensing policy is received; the sensing service is performed based on the information on the sensing policy to obtain the sensing data; in response to a subscription event of the sensing service being triggered, the sensing data is reported based on the information on the sensing policy.

In an embodiment, information on a sensing policy is received; the sensing service is performed based on the information on the sensing policy to obtain the sensing data; in response to receiving a reporting request sent by the NF, the sensing data is reported based on the information on the sensing policy.

In an embodiment, information on a sensing policy is received; the sensing service is performed based on the information on the sensing policy to obtain the sensing data; in response to obtaining the sensing data, based on the information on the sensing policy, the sensing data of the sensing service is reported according to the reporting mode of the sensing data indicated by the information on the sensing policy; where the sensing data indicates the features of the sensed object.

In an embodiment, information on a sensing policy is received; the sensing service is performed based on the information on the sensing policy to obtain the sensing data; in response to obtaining the sensing data, based on the information on the sensing policy, the sensing data of the sensing service is reported according to the reporting path of the sensing data indicated by the information on the sensing policy; where the sensing data indicates the features of the sensed object.

In an embodiment, information on a sensing policy is received; the sensing service is performed based on the information on the sensing policy to obtain the sensing data; in response to obtaining the sensing data, based on the information on the sensing policy, the sensing data of the sensing service is reported according to the reporting format of the sensing data indicated by the information on the sensing policy; where the sensing data indicates the features of the sensed object.

In an embodiment, information on a sensing policy is received; the sensing service is performed based on the information on the sensing policy to obtain the sensing data; in response to a subscription event of the sensing service being triggered, based on the information on the sensing policy, the sensing data of the sensing service is reported according to the reporting mode of the sensing data indicated by the information on the sensing policy; where the sensing data indicates the features of the sensed object.

In an embodiment, information on a sensing policy is received; the sensing service is performed based on the information on the sensing policy to obtain the sensing data; in response to a subscription event of the sensing service being triggered, based on the information on the sensing policy, the sensing data of the sensing service is reported according to the reporting path of the sensing data indicated by the information on the sensing policy; where the sensing data indicates the features of the sensed object.

In an embodiment, information on a sensing policy is received; the sensing service is performed based on the information on the sensing policy to obtain the sensing data; in response to a subscription event of the sensing service being triggered, based on the information on the sensing policy, the sensing data of the sensing service is reported according to the reporting format of the sensing data indicated by the information on the sensing policy; where the sensing data indicates the features of the sensed object.

In an embodiment, information on a sensing policy is received; the sensing service is performed based on the information on the sensing policy to obtain the sensing data; in response to receiving a reporting request sent by the NF, based on the information on the sensing policy, the sensing data of the sensing service is reported according to the reporting mode of the sensing data indicated by the information on the sensing policy; where the sensing data indicates the features of the sensed object.

In an embodiment, information on a sensing policy is received; the sensing service is performed based on the information on the sensing policy to obtain the sensing data; in response to receiving a reporting request sent by the NF, based on the information on the sensing policy, the sensing data of the sensing service is reported according to the reporting path of the sensing data indicated by the information on the sensing policy; where the sensing data indicates the features of the sensed object.

In an embodiment, information on a sensing policy is received; the sensing service is performed based on the information on the sensing policy to obtain the sensing data; in response to receiving a reporting request sent by the NF, based on the information on the sensing policy, the sensing data of the sensing service is reported according to the reporting format of the sensing data indicated by the information on the sensing policy; where the sensing data indicates the features of the sensed object.

It should be noted that those skilled in the art can understand that the methods provided in the embodiments of the present disclosure can be executed separately or together with some methods in the embodiments of the present disclosure or related technologies.

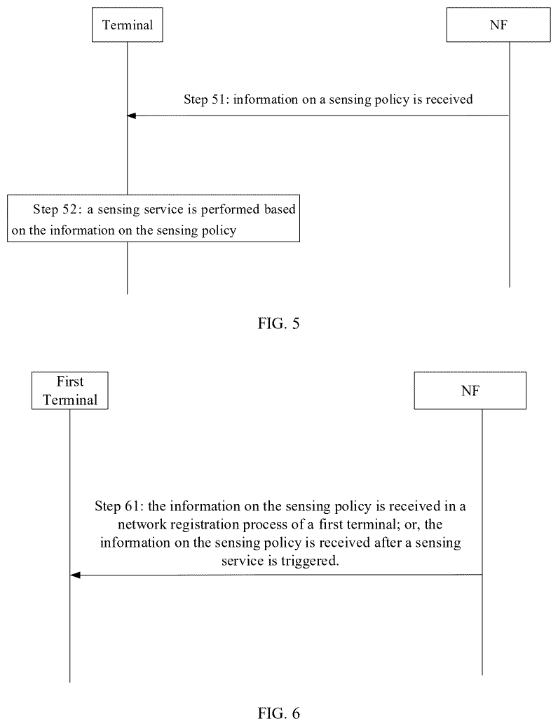

As shown in FIG. 5, this embodiment provides a method for reporting sensing data, which includes steps 51 and 52.

In step 51, information on a sensing policy is received.

In step 52, a sensing service is performed based on the information on the sensing policy.

Herein, the sensing service can be performed based on the information on the sensing policy to obtain the sensing data, where the sensing data indicates one or more features of a sensed object of the sensing service.

In an embodiment, information on a sensing policy is obtained; in response to a sensing application of a terminal triggering the sensing service, the sensing service is performed based on the information on the sensing policy to obtain the sensing data; based on the information on the sensing policy, the sensing data is reported, where the sensing data indicates the features of the sensed object. Herein, the sensing application of the terminal is an upper layer sensing application of a first terminal or an upper layer sensing application of a second terminal, where the second terminal is a sending end that sends sensing information to the first terminal.

In an embodiment, information on a sensing policy is obtained; in response to a sensing application of a base station triggering the sensing service, the sensing service is performed based on the information on the sensing policy to obtain the sensing data; based on the information on the sensing policy, the sensing data is reported, where the sensing data indicates the features of the sensed object.

In an embodiment, information on a sensing policy is obtained; in response to a network function (NF) triggering the sensing service, the sensing service is performed based on the information on the sensing policy to obtain the sensing data; based on the information on the sensing policy, the sensing data is reported, where the sensing data indicates the features of the sensed object. Herein, the NF can be a sensing application function of a network control plane.

In an embodiment, information on a sensing policy is obtained; in response to an application function (AF) triggering the sensing service, the sensing service is performed based on the information on the sensing policy to obtain the sensing data; based on the information on the sensing policy, the sensing data is reported, where the sensing data indicates the features of the sensed object.

In an embodiment, information on a sensing policy is obtained; in response to a sensing function (SF) triggering the sensing service, the sensing service is performed based on the information on the sensing policy to obtain the sensing data; based on the information on the sensing policy, the sensing data is reported, where the sensing data indicates the features of the sensed object.

It should be noted that those skilled in the art can understand that the methods provided in the embodiments of the present disclosure can be executed separately or together with some methods in the embodiments of the present disclosure or related technologies.

As shown in FIG. 6, this embodiment provides a method for reporting sensing data, which includes step 61.

In step 61, the information on the sensing policy is received in a network registration process of a first terminal;
or,
the information on the sensing policy is received after a sensing service is triggered.

In an embodiment, during the network registration process of the first terminal, the information on the sensing policy is received. Based on the information on the sensing policy, the sensing data of the sensing service is reported. The sensing data indicates one or more features of the sensed object.

In an embodiment, after the sensing service is triggered, the information on the sensing policy is received. Based on the information on the sensing policy, the sensing data of the sensing service is reported. The sensing data indicates the features of the sensed object.

It should be noted that those skilled in the art can understand that the methods provided in the embodiments of the present disclosure can be executed separately or together with some methods in the embodiments of the present disclosure or related technologies.

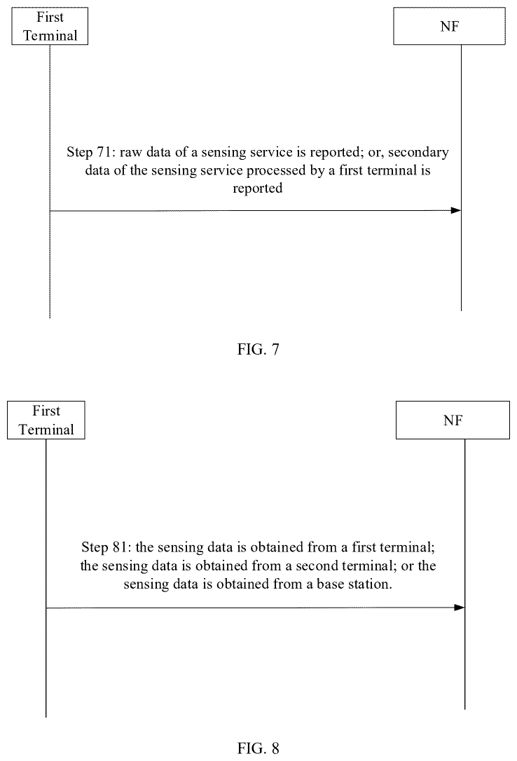

As shown in FIG. 7, this embodiment provides a method for reporting sensing data, which includes step 71.

In step 71: raw data of a sensing service is reported;
or,
secondary data of the sensing service processed by a first terminal is reported.

In an embodiment, in response to obtaining the sensing data of the sensing service, based on information on a sensing policy, the sensing data of the sensing service is reported; where the sensing data indicates one or more features of the sensed object. It should be noted that the sensing data reported by the first terminal is the raw data obtained by the first terminal. After obtaining the raw data, a network performs preprocessing on the raw data.

In an embodiment, in response to obtaining the sensing data of the sensing service, preprocessing is performed on the sensing data of the sensing service; based on the information on the sensing policy, the preprocessed sensing data of the sensing service (corresponding to the secondary data of the sensing service) is reported, where the sensing data indicates the features of the sensed object. It should be noted that the preprocessing can be that one or more predetermined features are extracted from the raw data indicating the sensing data.

It should be noted that those skilled in the art can understand that the methods provided in the embodiments of the present disclosure can be executed separately or together with some methods in the embodiments of the present disclosure or related technologies.

In some embodiments, the sensing service is one of the following:
a sensing service triggered by a terminal application;
a sensing service triggered by a network function (NF); or
a sensing service triggered by an application function (AF).

As shown in FIG. 8, this embodiment provides a method for reporting sensing data, which includes step 81.

In step 81, the sensing data is obtained from a first terminal;
the sensing data is obtained from a second terminal; or
the sensing data is obtained from a base station.

In an embodiment, sensing data of a sensing service is obtained from the first terminal; based on information on a sensing policy, the sensing data of the sensing service is reported; where the sensing data indicates one or more features of the sensed object.

In an embodiment, the sensing data of the sensing service is obtained from the base station; based on the information on the sensing policy, the sensing data of the sensing service is reported; where the sensing data indicates the features of the sensed object. Herein, the sensing data of the sensing service sent by the base station can be received.

In an embodiment, the sensing data of the sensing service is obtained from the second terminal; based on the information on the sensing policy, the sensing data of the sensing service is reported; where the sensing data indicates the features of the sensed object. The sensing data sent by the second terminal can be received.

It should be noted that those skilled in the art can understand that the methods provided in the embodiments of the present disclosure can be executed separately or together with some methods in the embodiments of the present disclosure or related technologies.

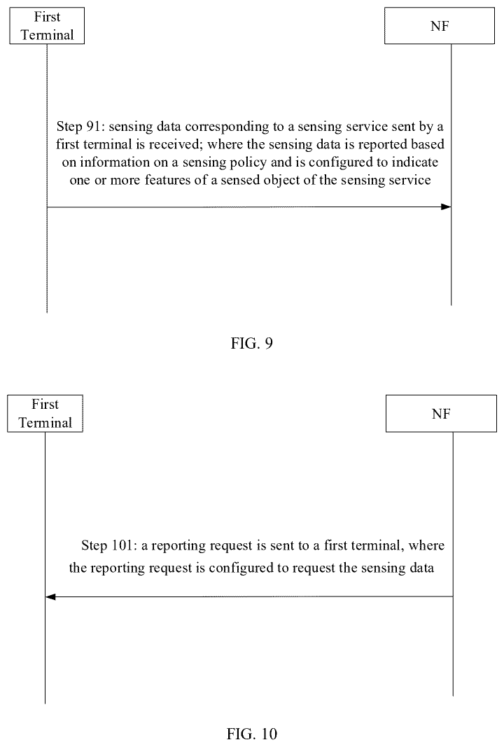

As shown in FIG. 9, this embodiment provides a method for reporting sensing data. The method is by a network function (NF) and includes step 91.

In step 91, sensing data corresponding to a sensing service sent by a first terminal is received.

The sensing data is reported based on information on a sensing policy and is configured to indicate one or more features of a sensed object of the sensing service.

Herein, the terminal involved in the present disclosure may be, but is not limited to, a mobile phone, a wearable device, a vehicle-mounted terminal, and a road side unit (RSU), a smart home terminal, an industrial sensing device, and/or a medical device, etc. In some embodiments, the terminal may be a Redcap terminal or a new radio (NR) terminal of a predetermined version (for example, a NR terminal of R17).

The base station involved in the present disclosure may be an access device for a terminal to access a network. Herein, the base station can be various types of base stations, for example, a base station of the third generation mobile communication (3G) network, a base station of the fourth generation mobile communication (4G) network, a base station of the fifth generation mobile communication (5G) network, or other evolved base station.

In the embodiment of the present disclosure, the first terminal can report the sensing data of the sensing service to the NF based on the information on the sensing policy. The NF receives the sensing data. The NF can execute applications in different scenarios based on the received sensing data. A device with the NF can be a core network device. The core network device may be a device with an access and mobility management function (AMF), a session management function (SMF), a sensing function (SF) or a policy control function (PCF).

In an embodiment, the sensing data reported by the first terminal can be received through a control plane network function (NF). The control plane NF includes one or more of the following: an access and mobility management function (AMF), a session management function (SMF), and a policy control function (PCF). For example, a SF can receive the sensing data sent by the first terminal through the control plane NF.

In an embodiment, based on the information on the sensing policy, the first terminal reports the sensing data of the sensing service to the NF through a base station in an access network, where the sensing data indicates the features of the sensed object of the sensing service. The NF receives the sensing data. It should be noted that the features of the sensed object can be at least one of features such as a speed, a shape, and a location of the sensed object.

In an embodiment, during a network registration process of the first terminal, the NF sends the information on the sensing policy to the first terminal. The first terminal reports the sensing data corresponding to the sensing service based on the information on the sensing policy; where the sensing data indicates the features of the sensed object. The NF receives the sensing data.

In an embodiment, after the sensing service is triggered, the NF sends the information on the sensing policy to the first terminal. The first terminal reports the sensing data corresponding to the sensing service based on the information on the sensing policy; where the sensing data indicates the features of the sensed object. The NF receives the sensing data.

Herein, the information on the sensing policy can indicate a policy for reporting the sensing data and/or a policy for executing the sensing service.

In some embodiments, the information on the sensing policy indicates one or more of the following of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, and a type of a sensing signal.

In some embodiments, the type of the sensing service may be one of the following: a service type that senses a shape of a target object, a service type that senses a position of the target object, or a service type that senses a running speed of the target object.

In other embodiments, the type of the sensing service may be one of the following: a sensing service type where both the transmitter and the receiver of the sensing signal are terminals, a sensing service type where the transmitter of the sensing signal is a base station and the receiver is a terminal, or a sensing service type where the transmitter and the receiver of the sensing signal are different terminals.

In an embodiment, the type of the sensed object may be a type of a sensed target object, such as a moving target or a stationary target.

In an embodiment, the NF receives the sensing data of the sensing service reported according to the reporting mode of the sensing data indicated by the information on the sensing policy; where the sensing data indicates the features of the sensed object. Herein, the reporting mode of the sensing data can be a reporting manner, for example, a manner in reporting according to a predetermined period.

In an embodiment, the NF receives the sensing data of the sensing service reported according to the reporting path of the sensing data indicated by the information on the sensing policy; where the sensing data indicates the features of the sensed object. Herein, the reporting path of the sensing data can be a path for the first terminal to report the sensing data through a base station.

In an embodiment, the NF receives the sensing data of the sensing service reported according to the reporting format of the sensing data indicated by the information on the sensing policy; where the sensing data indicates the features of the sensed object.

In an embodiment, the first terminal obtains the sensing data corresponding to the sensing service from the first terminal. The first terminal reports the sensing data corresponding to the sensing service based on the information on the sensing policy, where the sensing data indicates the features of the sensed object. The NF receives the sensing data.

In an embodiment, the first terminal obtains the sensing data corresponding to the sensing service from a base station. Here, the first terminal can receive the sensing data of the sensing service sent by the base station. The first terminal reports the sensing data of the sensing service based on the information on the sensing policy, where the sensing data indicates the features of the sensed object. The NF receives the sensing data.

In an embodiment, the first terminal obtains the sensing data corresponding to the sensing service from a second terminal. Here, the first terminal can receive the sensing data sent by second terminal. The first terminal reports the sensing data of the sensing service based on the information on the sensing policy, where the sensing data indicates the features of the sensed object. The NF receives the sensing data.

In an embodiment, in response to obtaining the sensing data corresponding to the sensing service, the first terminal reports the sensing data corresponding to the sensing service based on the information on the sensing policy, where the sensing data indicates the features of the sensed object. The NF receives the sensing data. It should be noted that the sensing data reported by the first terminal is raw data obtained by the first terminal. After obtaining the raw data, the NF performs preprocessing on the raw data.

In an embodiment, in response to obtaining the sensing data of the sensing service, the first terminal performs preprocessing on the sensing data of the sensing service. The first terminal reports preprocessed sensing data of the sensing service based on the information on the sensing policy, where the sensing data indicates the features of the sensed object. The NF receives the sensing data. It should be noted that the preprocessing can be that the first terminal extracts one or more predetermined features from the raw data of the sensing data.

In an embodiment, in response to a subscription event of the sensing service being triggered, the first terminal obtains the sensing data of the sensing service. The first terminal reports the sensing data based on the information on the sensing policy, where the sensing data indicates the features of the sensed object. The NF receives the sensing data.

In an embodiment, the NF sends a reporting request to the first terminal. In response to the first terminal receiving the reporting request, the first terminal obtains the sensing data corresponding to the sensing service. The first terminal reports the sensing data based on the information on the sensing policy, where the sensing data indicates the features of the sensed object. The NF receives the sensing data.

In an embodiment, the first terminal receives the information on the sensing policy. The first terminal executes the sensing service based on the information on the sensing policy to obtain the sensing data. The first terminal reports the sensing data based on the information on the sensing policy, where the sensing data indicates the features of the sensed object. The NF receives the sensing data.

In an embodiment, the first terminal obtains the information on the sensing policy. In response to a sensing application of a terminal triggering the sensing service, the first terminal executes the sensing service based on the information on the sensing policy to obtain the sensing data. The first terminal reports the sensing data based on the information on the sensing policy, where the sensing data indicates the features of the sensed object. The NF receives the sensing data. Herein, the sensing application of the terminal is an upper layer sensing application of the first terminal or an upper layer sensing application of a second terminal, where the second terminal is a sending end that sends sensing information to the first terminal.

In an embodiment, the first terminal obtains the information on the sensing policy. In response to a sensing application of a base station triggering the sensing service, the first terminal executes the sensing service based on the information on the sensing policy to obtain the sensing data. The first terminal reports the sensing data based on the information on the sensing policy, where the sensing data indicates the features of the sensed object. The NF receives the sensing data.

In an embodiment, the first terminal obtains the information on the sensing policy. In response to the NF triggering the sensing service, the first terminal executes the sensing service based on the information on the sensing policy to obtain the sensing data. The first terminal reports the sensing data based on the information on the sensing policy, where the sensing data indicates the features of the sensed object. The NF receives the sensing data. Herein, the NF can be a sensing application function of a network control plane.

In an embodiment, the first terminal obtains the information on the sensing policy. In response to an application function (AF) triggering the sensing service, the first terminal executes the sensing service based on the information on the sensing policy to obtain the sensing data. The first terminal reports the sensing data based on the information on the sensing policy, where the sensing data indicates the features of the sensed object. The NF receives the sensing data.

In an embodiment, the first terminal obtains the information on the sensing policy. In response to a sensing function (SF) triggering the sensing service, the first terminal executes the sensing service based on the information on the sensing policy to obtain the sensing data. The first terminal reports the sensing data based on the information on the sensing policy, where the sensing data indicates the features of the sensed object. The NF receives the sensing data.

It should be noted that those skilled in the art can understand that the methods provided in the embodiments of the present disclosure can be executed separately or together with some methods in the embodiments of the present disclosure or related technologies.

In an embodiment, the information on the sensing policy indicates one or more of the following of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, and a type of a sensing signal.

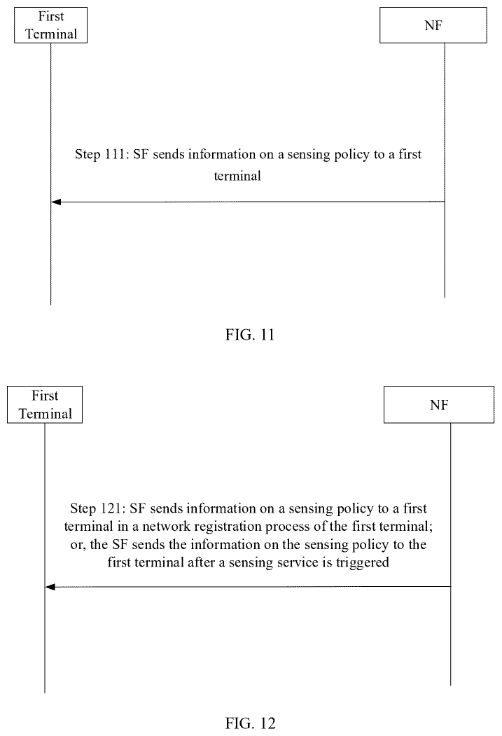

As shown in FIG. 10, this embodiment provides a method for reporting sensing data. The method is performed by a network function (NF) and includes step 101.

In step 101, a reporting request is sent to a first terminal, where the reporting request is configured to request the sensing data.

In an embodiment, the first terminal receives information on a sensing policy. The first terminal executes a sensing service based on the information on the sensing policy to obtain the sensing data. The NF sends the reporting request to the first terminal. In response to the first terminal receiving the reporting request, the first terminal reports the sensing data based on the information on the sensing policy. The NF receives the sensing data.

In an embodiment, the first terminal receives information on a sensing policy. The first terminal executes a sensing service based on the information on the sensing policy to obtain the sensing data. The NF sends the reporting request to the first terminal. In response to the first terminal receiving the reporting request, based on the information on the sensing policy, the first terminal reports the sensing data of the sensing service according to a reporting mode of the sensing data indicated by the information on the sensing policy; where sensing data indicates the features of the sensed object. The NF receives the sensing data.

In an embodiment, the first terminal receives information on a sensing policy. The first terminal executes a sensing service based on the information on the sensing policy to obtain the sensing data. The NF sends the reporting request to the first terminal. In response to the first terminal receiving the reporting request, based on the information on the sensing policy, the first terminal reports the sensing data of the sensing service according to a reporting path of the sensing data indicated by the information on the sensing policy; where sensing data indicates the features of the sensed object. The NF receives the sensing data.

In an embodiment, the first terminal receives information on a sensing policy. The first terminal executes a sensing service based on the information on the sensing policy to obtain the sensing data. The NF sends the reporting request to the first terminal. In response to the first terminal receiving the reporting request, based on the information on the sensing policy, the first terminal reports the sensing data of the sensing service according to a reporting format of the sensing data indicated by the information on the sensing policy; where sensing data indicates the features of the sensed object. The NF receives the sensing data.

It should be noted that those skilled in the art can understand that the methods provided in the embodiments of the present disclosure can be executed separately or together with some methods in the embodiments of the present disclosure or related technologies.

As shown in FIG. 11, this embodiment provides a method for reporting sensing data. The method is performed by a network function (NF) and includes step 111.

In step 111, a sensing function (SF) sends information on a sensing policy to a first terminal.

In some embodiments, the SF is a separately deployed NF, or the SF is a logical function of a predetermined NF, used for one or more sensing services.

In an embodiment, the SF sends the information on the sensing policy to the first terminal. The first terminal obtains the information on the sensing policy. In response to a sensing application of a terminal triggering a sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data. Herein, the sensing application of the terminal is an upper layer sensing application of the first terminal or an upper layer sensing application of a second terminal, where the second terminal is a sending end that sends sensing information to the first terminal.

In an embodiment, the SF sends the information on the sensing policy to the first terminal. The first terminal obtains the information on the sensing policy. In response to a sensing application of a base station triggering a sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

In an embodiment, the SF sends the information on the sensing policy to the first terminal. The first terminal obtains the information on the sensing policy. In response to the NF triggering a sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data. Herein, the NF can be a sensing application function of a network control plane.

In an embodiment, the SF sends the information on the sensing policy to the first terminal. The first terminal obtains the information on the sensing policy. In response to an application function (AF) triggering a sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

In an embodiment, the SF sends the information on the sensing policy to the first terminal. The first terminal obtains the information on the sensing policy. In response to the SF triggering a sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

It should be noted that those skilled in the art can understand that the methods provided in the embodiments of the present disclosure can be executed separately or together with some methods in the embodiments of the present disclosure or related technologies.

As shown in FIG. 12, this embodiment provides a method for reporting sensing data. The method is performed by a network function (NF) and includes step 121.

In step 121, a sensing function (SF) sends information on a sensing policy to a first terminal in a network registration process of the first terminal;
or,
the SF sends the information on the sensing policy to the first terminal after a sensing service is triggered.

In some embodiments, the SF is a separately deployed NF, or the SF is a logical function of a predetermined NF, used for one or more sensing services.

In an embodiment, in the network registration process of the first terminal, the SF sends the information on the sensing policy to the first terminal. The first terminal reports sensing data of the sensing service based on the information on the sensing policy; where the sensing data indicates one or more features of a sensed object. The SF receives the sensing data.

In an embodiment, after the sensing service is triggered, a network device sends the information on the sensing policy to the first terminal. The first terminal reports sensing data of the sensing service based on the information on the sensing policy; where the sensing data indicates one or more features of a sensed object. The SF receives the sensing data.

It should be noted that those skilled in the art can understand that the methods provided in the embodiments of the present disclosure can be executed separately or together with some methods in the embodiments of the present disclosure or related technologies.

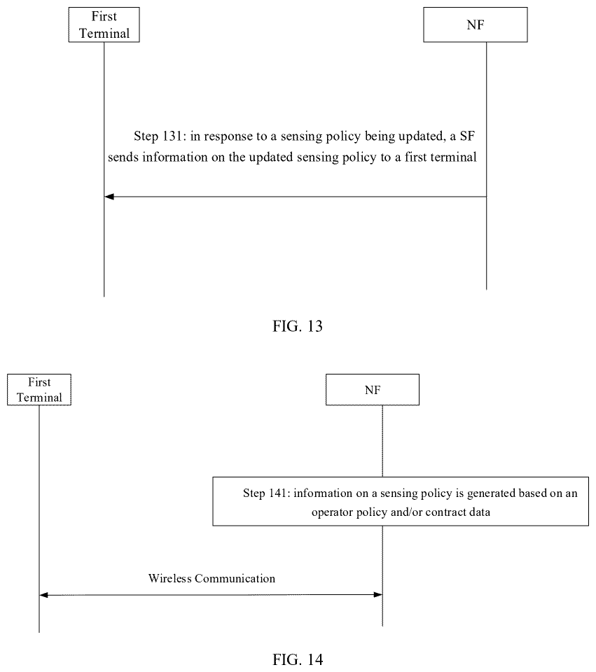

As shown in FIG. 13, this embodiment provides a method for reporting sensing data. The method is performed by a network function (NF) and includes step 131.

In step 131, in response to a sensing policy being updated, a sensing function (SF) sends information on the updated sensing policy to a first terminal.

In some embodiments, the SF is a separately deployed NF, or the SF is a logical function of a predetermined NF, used for one or more sensing services.

In an embodiment, in response to the sensing policy being updated, the SF sends the information on the updated sensing policy to the first terminal. Based on the information on the sensing policy, the first terminal reports sensing data of a sensing service to the NF through a base station in an access network, where the sensing data indicates one or more features of a sensed object. The NF receives the sensing data. It should be noted that the features of the sensed object can be at least one of features such as a speed, a shape, and a location of the sensed object.

In an embodiment, the SF can update the information on the sensing policy based on an operator policy and/or contract data.

It should be noted that those skilled in the art can understand that the methods provided in the embodiments of the present disclosure can be executed separately or together with some methods in the embodiments of the present disclosure or related technologies.

As shown in FIG. 14, this embodiment provides a method for reporting sensing data. The method is performed by a network function (NF) and includes step 141.

In step 141, information on a sensing policy is generated based on an operator policy and/or contract data.

In an embodiment, the NF generates the information on the sensing policy based on the operator policy and/or the contract data; and sends updated information on the sensing policy to a first terminal. Based on the information on the sensing policy, the first terminal reports sensing data of a sensing service to the NF through a base station in an access network, where the sensing data indicates one or more features of a sensed object. The NF receives the sensing data. It should be noted that the features of the sensed object can be at least one of features such as a speed, a shape, and a location of the sensed object.

It should be noted that the information on the sensing policy can be generated by one of the following of the NF: a sensing function (SF), a policy control function (PCF), an access and mobility management function (AMF), a session management function (SMF), an application function (AF), and a network data analytics function (NWDAF).

In an embodiment, a control plane NF can generate the information on the sensing policy based on the operator policy and/or the contract data. The control plane NF includes one or more of the following: an access and mobility management function (AMF), a session management function (SMF), and a policy control function (PCF).

It should be noted that those skilled in the art can understand that the methods provided in the embodiments of the present disclosure can be executed separately or together with some methods in the embodiments of the present disclosure or related technologies.

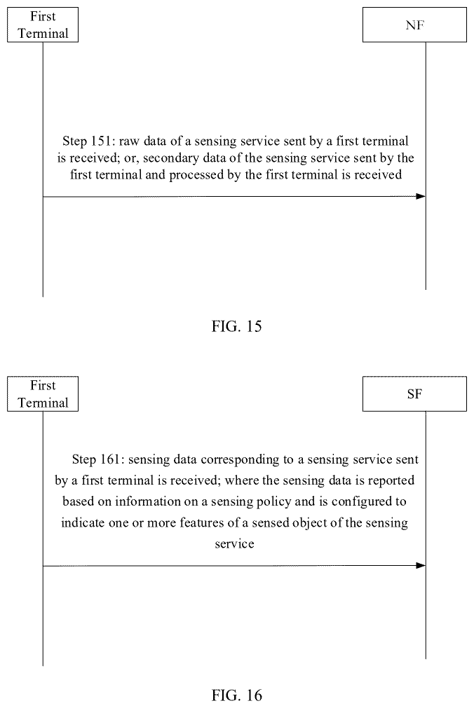

As shown in FIG. 15, this embodiment provides a method for reporting sensing data. The method is performed by a network function (NF) and includes step 151.

In step 151: raw data of a sensing service sent by a first terminal is received;
or,
secondary data of the sensing service sent by the first terminal and processed by the first terminal is received.

In an embodiment, in response to obtaining sensing data of the sensing service, the first terminal reports the sensing data of the sensing service based on information on a sensing policy, where the sensing data indicates one or more features of a sensed object. The NF receives the sensing data. It should be noted that the sensing data reported by the first terminal is the raw data obtained by the first terminal. After obtaining the raw data, the NF performs preprocessing on the raw data.

In an embodiment, in response to obtaining the sensing data of the sensing service, the first terminal performs preprocessing on the sensing data of the sensing service. The first terminal reports preprocessed sensing data of the sensing service (corresponding to the secondary data of the sensing service) based on the information on the sensing policy, where the sensing data indicates the features of the sensed object. The NF receives the sensing data. It should be noted that the preprocessing can be that one or more predetermined features are extracted from the raw data indicating the sensing data.

It should be noted that those skilled in the art can understand that the methods provided in the embodiments of the present disclosure can be executed separately or together with some methods in the embodiments of the present disclosure or related technologies.

In some embodiments, the sensing service is one of the following:
a sensing service triggered by a terminal application;
a sensing service triggered by a network function (NF); or
a sensing service triggered by an application function (AF).

As shown in FIG. 16, this embodiment provides a method for reporting sensing data. The method is performed by a sensing function (SF) and includes step 161.

In step 161, sensing data corresponding to a sensing service sent by a first terminal is received.

The sensing data is reported based on information on a sensing policy and is configured to indicate one or more features of a sensed object of the sensing service.

Herein, the terminal involved in the present disclosure may be, but is not limited to, a mobile phone, a wearable device, a vehicle-mounted terminal, and a road side unit (RSU), a smart home terminal, an industrial sensing device, and/or a medical device, etc. In some embodiments, the terminal may be a Redcap terminal or a new radio (NR) terminal of a predetermined version (for example, a NR terminal of R17).

The base station involved in the present disclosure may be an access device for a terminal to access a network. Herein, the base station can be various types of base stations, for example, a base station of the third generation mobile communication (3G) network, a base station of the fourth generation mobile communication (4G) network, a base station of the fifth generation mobile communication (5G) network, or other evolved base station.

In an embodiment, the SF can receive the sensing data reported by the first terminal through a control plane network function (NF). The control plane NF includes one or more of the following: an access and mobility management function (AMF), a session management function (SMF), and a policy control function (PCF).

Herein, the information on the sensing policy can indicate a policy for reporting the sensing data and/or a policy for executing the sensing service.

In some embodiments, the information on the sensing policy indicates one or more of the following of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, and a type of a sensing signal.

In some embodiments, the type of the sensing service may be one of the following: a service type that senses a shape of a target object, a service type that senses a position of the target object, or a service type that senses a running speed of the target object.

In other embodiments, the type of the sensing service may be one of the following: a sensing service type where both the transmitter and the receiver of the sensing signal are terminals, a sensing service type where the transmitter of the sensing signal is a base station and the receiver is a terminal, or a sensing service type where the transmitter and the receiver of the sensing signal are different terminals.

In an embodiment, the type of the sensed object may be a type of a sensed target object, for example, a moving target and a stationary target.

In an embodiment, the SF receives the sensing data of the sensing service reported according to the reporting mode of the sensing data indicated by the information on the sensing policy; where the sensing data indicates the features of the sensed object. Herein, the reporting mode of the sensing data can be a reporting manner, for example, a manner in reporting according to a predetermined period.

In an embodiment, the SF receives the sensing data of the sensing service reported according to the reporting path of the sensing data indicated by the information on the sensing policy; where the sensing data indicates the features of the sensed object. Herein, the reporting path of the sensing data can be a path for the first terminal to report the sensing data through a base station.

In an embodiment, the SF receives the sensing data of the sensing service reported according to the reporting format of the sensing data indicated by the information on the sensing policy; where the sensing data indicates the features of the sensed object.

It should be noted that those skilled in the art can understand that the methods provided in the embodiments of the present disclosure can be executed separately or together with some methods in the embodiments of the present disclosure or related technologies.

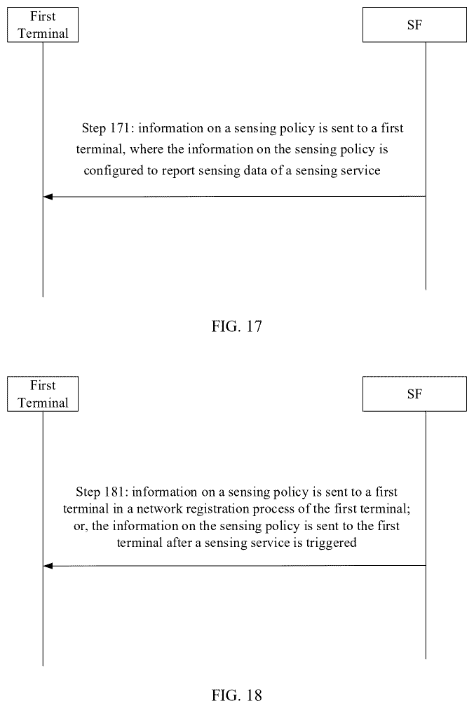

As shown in FIG. 17, this embodiment provides a method for reporting sensing data. The method is performed by a sensing function (SF) and includes step 171.

In step 171, information on a sensing policy is sent to a first terminal, where the information on the sensing policy is configured to report sensing data of a sensing service.

In an embodiment, the SF sends the information on the sensing policy to the first terminal. The first terminal obtains the information on the sensing policy. In response to a sensing application of a terminal triggering the sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data. Herein, the sensing application of the terminal is an upper layer sensing application of the first terminal or an upper layer sensing application of a second terminal, where the second terminal is a sending end that sends sensing information to the first terminal.

In an embodiment, the SF sends the information on the sensing policy to the first terminal. The first terminal obtains the information on the sensing policy. In response to a sensing application of a base station triggering the sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

In an embodiment, the SF sends the information on the sensing policy to the first terminal. The first terminal obtains the information on the sensing policy. In response to a network function (NF) triggering the sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data. Herein, the NF can be a sensing application function of a network control plane.

In an embodiment, the SF sends the information on the sensing policy to the first terminal. The first terminal obtains the information on the sensing policy. In response to an application function (AF) triggering the sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

In an embodiment, the SF sends the information on the sensing policy to the first terminal. The first terminal obtains the information on the sensing policy. In response to the SF triggering the sensing service, the first terminal executes the sensing service based on the information on the sensing policy to obtain the sensing data. The first terminal reports the sensing data based on the information on the sensing policy, where the sensing data indicates one or more features of a sensed object. The SF receives the sensing data.

It should be noted that those skilled in the art can understand that the methods provided in the embodiments of the present disclosure can be executed separately or together with some methods in the embodiments of the present disclosure or related technologies.

As shown in FIG. 18, this embodiment provides a method for reporting sensing data. The method is performed by a sensing function (SF) and includes step 181.

In step 181: information on a sensing policy is sent to a first terminal in a network registration process of the first terminal;
or,
the information on the sensing policy is sent to the first terminal after a sensing service is triggered.

In an embodiment, in the network registration process of the first terminal, the SF sends the information on the sensing policy to the first terminal. The first terminal reports sensing data of the sensing service based on the information on the sensing policy; where the sensing data indicates one or more features of a sensed object. The SF receives the sensing data.

In an embodiment, after the sensing service is triggered, a network device sends the information on the sensing policy to the first terminal. The first terminal reports sensing data of the sensing service based on the information on the sensing policy; where the sensing data indicates one or more features of a sensed object. The SF receives the sensing data.

It should be noted that those skilled in the art can understand that the methods provided in the embodiments of the present disclosure can be executed separately or together with some methods in the embodiments of the present disclosure or related technologies.

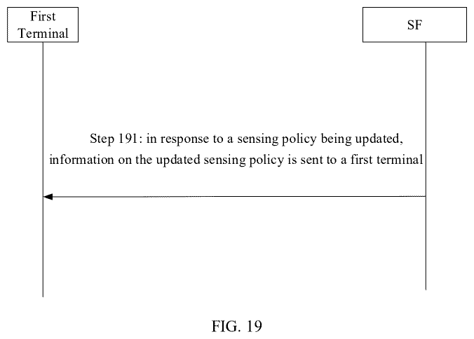

As shown in FIG. 19, this embodiment provides a method for reporting sensing data. The method is performed by a sensing function (SF) and includes step 191.

In step 191, in response to a sensing policy being updated, information on the updated sensing policy is sent to a first terminal.

In an embodiment, in response to the sensing policy being updated, the SF sends the information on the updated sensing policy to the first terminal. Based on the information on the sensing policy, the first terminal reports sensing data of a sensing service to a network function (NF) through a base station in an access network, where the sensing data indicates one or more features of a sensed object. The NF receives the sensing data. It should be noted that the features of the sensed object can be at least one of features such as a speed, a shape, and a location of the sensed object.

In an embodiment, the SF can update the information on the sensing policy based on an operator policy and/or contract data; the updated information on the sensing policy is sent to the first terminal. Or, the SF can obtain the information on the sensing policy updated based on the operator policy and/or the contract data from a control plane NF; the updated information on the sensing policy is sent to the first terminal. There is no limitation herein.

It should be noted that those skilled in the art can understand that the methods provided in the embodiments of the present disclosure can be executed separately or together with some methods in the embodiments of the present disclosure or related technologies.

In order to better understand the embodiments of the present disclosure, the technical solution of the present disclosure will be further explained by two exemplary embodiments.

### Example 1

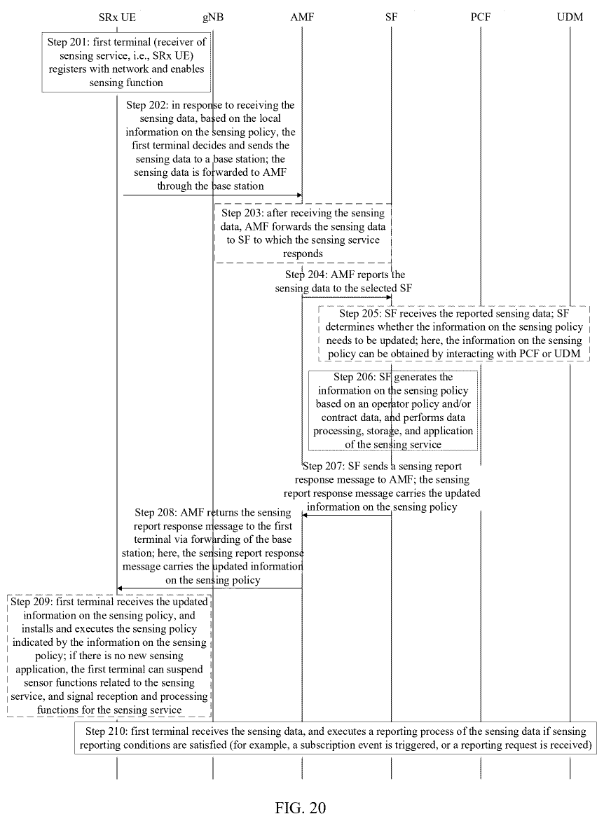

Referring to FIG. 20, a method for reporting sensing data is provided, which includes steps 201 to 210.

In step 201, a first terminal (which is a receiver of a sensing service, namely SRx UE) registers with a network and enables a sensing function. Herein, after the sensing function is enabled, if the first terminal receives information on a sensing policy, the first terminal will install and execute an enforcement policy indicated by the information on the sensing policy. When receiving the sensing data, the first terminal will trigger a data reporting and processing flow of the sensing service.

In step 202, in response to receiving the sensing data, based on the local information on the sensing policy, the first terminal makes a decision and sends the sensing data to a base station. The sensing data is forwarded to an access and mobility management function (AMF) through the base station and/or a control plane network function (NF). The control plane NF includes one or more of the following: an AMF, a session management function (SMF), or a policy control function (PCF). Herein, the sensing data indicates feature information related to a sensed object. Herein, the terminal can determine sensing data to be sent to the network based on the information on the sensing policy and the received sensing data.

In step 203, after receiving the sensing data, the AMF forwards the sensing data to a sensing function (SF) to which the sensing service responds. If the AMF does not have specific SF information, an appropriate SF can be discovered and selected through a network repository function (NRF).

In step 204, the AMF reports the sensing data to the selected SF. Herein, based on network deployment or sensing service characteristics, the AMF can forward sensing result data to the selected SF via the SMF and/or a network exposure function (NEF).

In step 205, the SF receives the reported sensing data. Herein, the SF determines whether the information on the sensing policy needs to be updated. Herein, the information on the sensing policy can be obtained by interacting with the PCF or a unified data management (UDM).

In step 206, the SF generates the information on the sensing policy based on an operator policy and/or contract data, and performs data processing, storage, and application of the sensing service.

In step 207, the SF sends a sensing report response message to the AMF. Herein, the sensing report response message carries the updated information on the sensing policy.

In step 208, the AMF returns the sensing report response message to the first terminal via forwarding of the base station. Herein, the sensing report response message carries the updated information on the sensing policy.

In step 209, the first terminal receives the updated information on the sensing policy, and installs and executes the sensing policy indicated by the information on the sensing policy. If there is no new sensing application, the first terminal can suspend sensor functions related to the sensing service, and signal reception and processing functions for the sensing service.

In step 210, the first terminal receives the sensing data, and executes a reporting process of the sensing data if sensing reporting conditions are satisfied (for example, a subscription event is triggered, or a reporting request is received).

It should be noted that those skilled in the art can understand that the methods provided in the embodiments of the present disclosure can be executed separately or together with some methods in the embodiments of the present disclosure or related technologies.

### Example 2

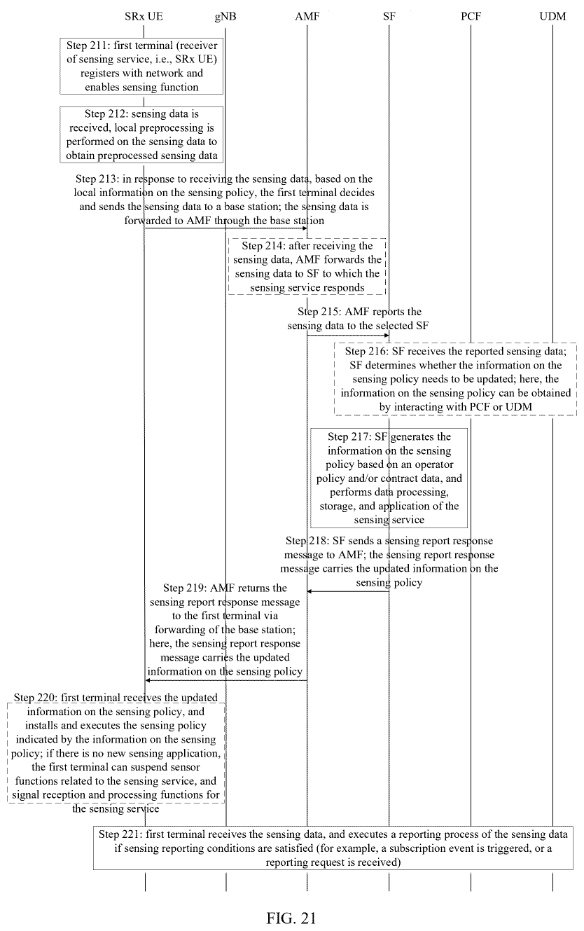

Referring to FIG. 21, a method for reporting sensing data is provided, which includes steps 211 to 221.

In step 211, a first terminal (which is a receiver of a sensing service, namely SRx UE) registers with a network and enables a sensing function. Herein, after the sensing function is enabled, if the first terminal receives information on a sensing policy, the first terminal will install and execute an enforcement policy indicated by the information on the sensing policy. When receiving the sensing data, the first terminal will trigger a data reporting and processing flow of the sensing service.

In step 212, sensing data is received, local preprocessing is performed on the sensing data to obtain preprocessed sensing data. Herein, the preprocessing process can include: classifying or extracting data after local processing by the terminal based on a local sensing function and sensing policy, or extracting a data processing result of the sensing function.

In step 213, based on the local information on the sensing policy, a decision is made and preprocessed sensing data is sent to a base station. The sensing data is forwarded to an access and mobility management function (AMF) through the base station. Herein, the sensing data indicates feature information related to a sensed object. Herein, the terminal can determine sensing data to be sent to the network based on the information on the sensing policy and the received sensing data.

In step 214, after receiving the sensing data, the AMF forwards the sensing data to a sensing function (SF) to which the sensing service responds. If the AMF does not have specific SF information, an appropriate SF can be discovered and selected through a network repository function (NRF).

In step 215, the AMF reports the sensing data to the selected SF. Herein, based on network deployment or sensing service characteristics, the AMF can forward sensing result data to the selected SF via a session management function (SMF) and/or a network exposure function (NEF).

In step 216, the SF receives the reported sensing data. Herein, the SF determines whether the information on the sensing policy needs to be updated. Herein, the information on the sensing policy can be obtained by interacting with the PCF or a unified data management (UDM).

In step 217, the SF generates the information on the sensing policy based on an operator policy and/or contract data, and performs data processing, storage, and application of the sensing service. Herein, it should be noted that the SF can directly execute the application if the data processing result of the sensing service is reported; if classified or extracted data after the processing is reported, the SF will perform secondary processing of the sensing data according to a network sensing policy and then executing the application.

In step 218, the SF sends a sensing report response message to the AMF. Herein, the sensing report response message carries the updated information on the sensing policy.

In step 219, the AMF returns the sensing report response message to the first terminal via forwarding of the base station. Herein, the sensing report response message carries the updated information on the sensing policy.

In step 220, the first terminal receives the updated information on the sensing policy, and installs and executes the sensing policy indicated by the information on the sensing policy. If there is no new sensing application, the first terminal can suspend sensor functions related to the sensing service, and signal reception and processing functions for the sensing service.

In step 221, the first terminal receives the sensing data, and executes a reporting process of the sensing data if sensing reporting conditions are satisfied (for example, a subscription event is triggered, or a reporting request is received).

As shown in FIG. 22, this embodiment provides an apparatus for reporting sensing data. The apparatus includes a reporting module 222.

The reporting module 222 is configured to report sensing data corresponding to a sensing service based on information on a sensing policy.

The sensing data indicates one or more features of a sensed object of the sensing service.

It should be noted that those skilled in the art can understand that the methods provided in the embodiments of the present disclosure can be executed separately or together with some methods in the embodiments of the present disclosure or related technologies.

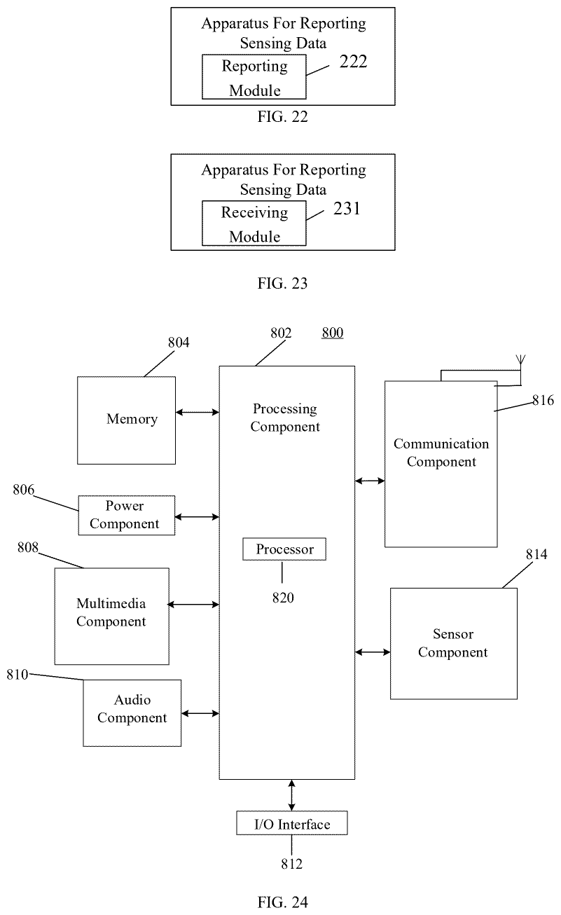

As shown in FIG. 23, this embodiment provides an apparatus for reporting sensing data. The apparatus includes a receiving module 231.

The receiving module 231 is configured to receive sensing data corresponding to a sensing service sent by a first terminal.

The sensing data is determined based on information on a sensing policy and is configured to indicate one or more features of a sensed object of the sensing service.

It should be noted that those skilled in the art can understand that the methods provided in the embodiments of the present disclosure can be executed separately or together with some methods in the embodiments of the present disclosure or related technologies.

An embodiment of the present disclosure provides a communication device, which includes:
a processor; and
a memory configured to store executable instructions by the processor.

The processor is configured to implement the method applied to any embodiment of the present disclosure when running the executable instructions.

The processor may include various types of storage media. The storage media are non-transitory computer storage media, and can continue to memorize information stored thereon after the communication device is powered down.

The processor can be connected to the memory through a bus or other means to read executable programs stored on the memory.

An embodiment of the present disclosure also provides a computer storage medium. The computer storage medium stores an executable program by a computer, and the executable program is executed by the processor to implement the method according to any embodiment of the present disclosure.

Regarding the apparatuses in the above embodiments, the specific ways in which each module performs operations have been described in detail in the relevant embodiments of the method, and will not be elaborated herein.

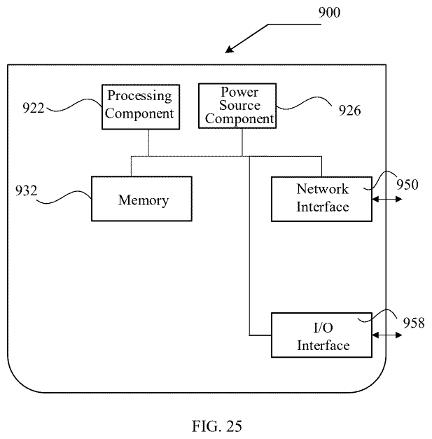

As shown in FIG. 24, an embodiment of the present disclosure provides a structure of a terminal.

FIG. 24 shows a terminal 800 according to the embodiment. The terminal may be a mobile phone, a computer, a digital broadcasting terminal, a messaging device, a game console, a tablet device, a medical device, a fitness device, a personal digital assistant, or the like.

Referring to FIG. 24, the terminal 800 can include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operations of the terminal 800, such as operations associated with display, telephone calls, data communications, camera operations, and recording operations. The processing component 802 can include one or more processors 820 to execute instructions to complete all or part of the steps of the above methods. In addition, the processing component 802 can include one or more modules to facilitate interaction between the processing component 802 and other components. For example, the processing component 802 can include a multimedia module to facilitate interaction between the multimedia component 808 and the processing component 802.

The memory 804 is configured to store various types of data to support operations at the terminal 800. Examples of such data include instructions for any application or method operating on the terminal 800, contact data, phone book data, messages, pictures, videos, and so on. The memory 804 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 806 provides power to various components of the terminal 800. The power component 806 can include a power management system, one or more power sources, and other components associated with generating, managing, and distributing power for the terminal 800.

The multimedia component 808 includes a screen that provides an output interface between the terminal 800 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor can not only sense boundaries of a touch or swipe action, but also detect the duration and pressure related to the touch or swipe action. In some embodiments, the multimedia component 808 includes a front camera and/or a rear camera. When the terminal 800 is in operation mode, such as shooting or video mode, the front camera and/or the rear camera can receive external multimedia data. Each of the front and rear cameras can be a fixed optical lens system or have focal length and optical zooming capabilities.

The audio component 810 is configured to output and/or input audio signals. For example, the audio component 810 includes a microphone (MIC) that is configured to receive external audio signals when the terminal 800 is in an operation mode, such as a call mode, a recording mode, and a voice recognition mode. The received audio signals can be further stored in the memory 804 or transmitted via the communication component 816. In some embodiments, the audio component 810 further includes a speaker for outputting audio signals.

The I/O interface 812 provides an interface between the processing component 802 and peripheral interface modules. The peripheral interface modules can be keyboards, a click wheels, a buttons, or the like. These buttons can include, but are not limited to, home button, volume button, start button, and lock button.

The sensor component 814 includes one or more sensors to provide terminal 800 with status assessment in various aspects. For example, the sensor component 814 can detect an open/closed state of the terminal 800, relative positioning of components, such as the display and keypad of the terminal 800. The sensor component 814 can also detect a change in position of the terminal 800 or a component of the terminal 800, the presence or absence of user contact with the terminal 800, orientation or acceleration/deceleration of the terminal 800, and temperature change of the terminal 800. The sensor component 814 can include a proximity sensor configured to detect the presence of nearby objects without any physical contact. The sensor component 814 can also include a light sensor, such as a Complementary Metal-Oxide-Semiconductor (CMOS) or Charged Coupled Device (CCD) image sensor, for use in imaging applications. In some embodiments, the sensor component 814 can further include an acceleration sensor, a gyro sensor, a magnetic sensor, a pressure sensor, or a temperature sensor.

The communication component 816 is configured to facilitate wired or wireless communication between the terminal 800 and other devices. The terminal 800 can access a wireless network based on a communication standard, such as Wi-Fi, 2G or 3G, or a combination thereof. In an exemplary embodiment, the communication component 816 receives broadcast signals or broadcast-related information from an external broadcast management system via a broadcast channel. In one exemplary embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the terminal 800 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for performing the above methods.

In an exemplary embodiment, there is also provided a non-transitory computer readable storage medium including instructions, such as the memory 804 including executable instructions executable by the processor 820 of the terminal 800 to implement the above methods. For example, the non-transitory computer readable storage medium can be a ROM, a random access memory (RAM), a CD-ROM, a magnetic tape, a floppy disk, and an optical data storage device, etc.

As shown in FIG. 25, an embodiment of the present disclosure illustrates a structure of a base station. For example, the base station 900 can be provided as a network side device. Referring to FIG. 25, the base station 900 includes a processing component 922, which further includes one or more processors, and memory resources represented by a memory 932, for storing instructions that can be executed by the processing component 922, such as an application program. The application program stored in the memory 932 may include one or more modules each corresponding to a set of instructions. In addition, the processing component 922 is configured to execute instructions to perform any of the above methods applied to the base station.

The base station 900 may also include a power component 926 configured to perform power management for the base station 900, a wired or wireless network interface 950 configured to connect the base station 900 to the network, and an input/output (I/O) interface 958. The base station 900 can operate based on an operating system stored in the memory 932, for example, Windows Server™, Mac OS X™, Unix™, Linux™, FreeBSD™, or similar.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the present disclosure is not limited to the precise structure that has been described above and shown in the drawings, and various modifications and changes may be made without departing from the scope thereof. The scope of the present disclosure is limited only by the appended claims.

1. A method for reporting sensing data, performed by a first terminal, the method comprising:
reporting sensing data corresponding to a sensing service based on information on a sensing policy;
wherein the sensing data is configured to indicate one or more features of a sensed object of the sensing service.

2. The method according to claim 1, wherein reporting the sensing data corresponding to the sensing service comprises:
reporting the sensing data through a control plane network function (NF);
wherein the control plane NF comprises one or more of: an access and mobility management function (AMF), a session management function (SMF), and a policy control function (PCF).

3. The method according to claim 1, wherein the method comprises at least one of:
the information on the sensing policy indicates one or more of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, or a type of a sensing signal;
or,
reporting the sensing data corresponding to the sensing service based on the information on the sensing policy comprises:
obtaining the sensing data, and reporting the sensing data based on the information on the sensing policy; or
a subscription event of the sensing service being triggered, reporting the sensing data based on the information on the sensing policy; or
receiving a reporting request sent by a network function (NF), and reporting the sensing data based on the information on the sensing policy.

4. (canceled)

5. The method according to claim 1, further comprising:
receiving the information on the sensing policy;
performing the sensing service based on the information on the sensing policy;
wherein receiving the information on the sensing policy comprises:
receiving the information on the sensing policy in a network registration process of the first terminal; or
receiving the information on the sensing policy after the sensing service is triggered.

6. (canceled)

7. The method according to claim 1, wherein the method comprises at least one of:
reporting the sensing data corresponding to the sensing service comprises:
reporting raw data of the sensing service; or
reporting secondary data of the sensing service processed by the first terminal;
or,
the sensing service comprises one of:
a sensing service triggered by a terminal application;
a sensing service triggered by a network function (NF); or
a sensing service triggered by an application function (AF).

8. (canceled)

9. The method according to claim 1, wherein further comprising one of:
obtaining the sensing data from the first terminal;
obtaining the sensing data from a second terminal; or
obtaining the sensing data from a base station.

10. A method for reporting sensing data, performed by a network function (NF), the method comprising:
receiving sensing data corresponding to a sensing service sent by a first terminal;
wherein the sensing data is reported based on information on a sensing policy and is configured to indicate one or more features of a sensed object of the sensing service.

11. The method according to claim 10, wherein receiving the sensing data corresponding to the sensing service sent by the first terminal comprises:
receiving the sensing data through a control plane network function (NF);
wherein the control plane NF comprises one or more of: an access and mobility management function (AMF), a session management function (SMF), and a policy control function (PCF).

12. The method according to claim 11, wherein the method further comprises at least one of:
the information on the sensing policy indicates one or more of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, or a type of a sensing signal; or
sending a reporting request to the first terminal, wherein the reporting request is configured to request the sensing data.

13. (canceled)

14. The method according to claim 10, wherein the NF is a control plane NF; and the method further comprises:
generating the information on the sensing policy based on an operator policy and/or contract data.

15. The method according to claim 10, wherein the method comprises at least one of:
receiving the sensing data corresponding to the sensing service sent by the first terminal comprises:
receiving raw data of the sensing service sent by the first terminal; or
receiving secondary data of the sensing service sent and processed by the first terminal;
or.
the sensing service comprises one of:
a sensing service triggered by a terminal application;
a sensing service triggered by a network function (NF); or a sensing service triggered by an application function (AF).

16. (canceled)

17. A method for reporting sensing data, performed by a sensing function (SF), the method comprising:
receiving sensing data corresponding to a sensing service sent by a first terminal;
wherein the sensing data is reported based on information on a sensing policy and is configured to indicate one or more features of a sensed object of the sensing service.

18. The method according to claim 17, wherein the information on the sensing policy indicates one or more of the sensing service: a type of the sensing service, a type of the sensed object, a collection manner of the sensing data, a collection frequency of the sensing data, sensing time, a sensing period, a reporting mode of the sensing data, a reporting path of the sensing data, a reporting subscription event of the sensing data, a reporting format of the sensing data, a sensing area, or a type of a sensing signal.

19. The method according to claim 17, further comprising:
sending the information on the sensing policy to the first terminal, wherein the information on the sensing policy is configured to report the sensing data of the sensing service;
wherein sending the information on the sensing policy to the first terminal comprises at least one of:
sending the information on the sensing policy to the first terminal in a network registration process of the first terminal;
sending the information on the sensing policy to the first terminal after the sensing service is triggered; or
the sensing policy being updated, sending information on the updated sensing policy to the first terminal.

20.-23. (canceled)

24. A communication device, comprising:
a memory; and
one or more processors communicatively coupled, to the memory, and collectively configured to implement the method according to 1 by executing computer-executable instructions stored on the memory.

25. A non-transitory computer storage medium storing computer-executable instructions that, when executed by a processor cause the processor to perform the method according to 1.

26. A communication device, comprising:
a memory; and
one or more processors communicatively coupled to the memory, and collectively configured to implement the method according to claim 10 by executing computer-executable instructions stored on the memory.

27. A communication device, comprising:
a memory; and
one or more processors communicatively coupled to the memory, and collectively configured to implement the method according to claim 17 by executing computer-executable instructions stored on the memory.

28. A non-transitory computer storage medium storing computer-executable instructions that, when executed by a processor, cause the processor to perform the method according to claim 10.

29. A non-transitory computer storage medium storing computer-executable instructions that, when executed by a processor, cause the processor to perform according to claim 17.
